(19) United States
(12) Patent Application Publication
(10) Pub. No.: US 2016/0037975 A1
(43) Pub. Date: Feb. 11, 2016

(54) Multi-Fit, Fast Connect, Dispenser to Bottle 8 Connection Kit for Liquid Dispensers

(71) Applicants: Russell M. Rice, Avon, CO (US); Stephanie S. Rice, New York, NY (US)

(72) Inventors: Russell M. Rice, Avon, CO (US); Stephanie S. Rice, New York, NY (US)

(21) Appl. No.: 14/820,168

(22) Filed: Aug. 6, 2015

Related U.S. Application Data
(60) Provisional application No. 62/033,753, filed on Aug. 6, 2014.

(51) Int. Cl. A47K 5/12; F16L 25/14; F16L 21/08; F16L 25/00; F16L 37/02; F16L 37/26

(52) U.S. Cl. CPC A47K 5/1211; F16L 37/02; F16L 37/26; F16L 21/08; F16L 25/0018; F16L 25/14

(57) ABSTRACT

A multi-fit, fast connect, bottle-to-dispenser system for connecting a liquid dispensing pump to a liquid reserve has a universal adapter. The universal adapter attaches to a neck of a bottle and has a first fitting and a second fitting being concentrically stacked, wherein the first fitting has a first plurality of ribs of a first diameter and the second fitting has a second plurality of ribs of a second diameter. The first fitting forming a seal with the neck of smaller bottles and the second fitting forming a seal with the neck of larger bottles. A pass through channel traverses through the first fitting and the second fitting, and allows a connecting tube to be positioned through the universal adapter into the bottle. A dispenser coupling is terminally connected to the connecting tube opposite the universal adapter, joining the connecting tube to a down stem of the liquid dispensing pump.

The current application claims a priority to the U.S. Provisional Patent application Ser. No. 62/033,753 filed on Aug. 6, 2014.

### FIELD OF THE INVENTION

The present invention relates generally to integrated soap and lotion dispensing systems for kitchen and baths. More specifically, the present invention is a retro-fit kit for existing soap and lotion dispensing systems, in particular dispensers integrated into the sink or counter. The kit connects the dispenser that is located on the counter to any bottle of liquid soap underneath the counter through a universal adapter, a connecting tube, and a coupling fitting.

### BACKGROUND OF THE INVENTION

In recent years, liquid soap has become extremely popular, substantially surpassing bars of soap on the market. Liquid soap is significantly more convenient, cheaper to transport, leaves no mess behind, and provides various additives necessary for healthy skin. Liquid pump dispensers are used in conjunction with liquid soap to allow the user to easily and conveniently obtain a small increment to be used for washing and the like. A large market of this field is devoted to soap dispensers that are integrated into the counter and/or the sink. While this has revolutionized the design and utility of the sink, it is unfortunately flawed. Small, below counter, reservoir bottle technology is so seriously flawed that it drives a large percentage of people who buy and initially use counter mounted dispensers to cease using them within one year. They simply get tired of the inconvenient frequent refills and messy cleanups associated with the reservoir technology.

Traditional designs for counter based liquid dispensers involve the pump being integrated into the counter with the bottle of liquid coupled directly to the pump, right underneath the counter/sink. To refill said bottle, the user unscrews the dispensing pump and pours the liquid into the tiny one inch neck of the bottle which cannot be seen. This design makes it virtually impossible to refill the bottle accurately. The overflow of the reservoir results in liquid spilling onto the countertop area surrounding the dispenser. This is both frustrating and time consuming for the user to clean up. Under filling results from an effort to avoid overfilling, but does little to alleviate the problem. Even when under filling, it is still common for soap to drip or spill outside of the reservoir opening as it is being poured.

In an effort to avoid this design, retro-fit kits have been designed to connect liquid dispensers to a regular bottle of soap stationed below the counter. However, such retro-fit kits are not without problems either. A typical retro-fit kit for a liquid dispenser includes a tube and at least one bottle fitting that supports the tube and covers the bottle. The bottle fitting is attached to the neck of the bottle, while the tube is positioned through the bottle fitting and attached to the pump below the counter. One design of said bottle fittings provides multiple caps of various sizes, each corresponding to a different bottle neck size. It is burdensome to keep track of all of the caps, and caps can easily be lost. Furthermore, not all bottle necks have the same thread count, which would therefore render the caps useless if the thread count of the neck and cap do not match.

Another bottle fitting design is that of a tapered plug. The tapered plug improves upon the use of caps in that it is a single piece design that can fit into multiple bottle neck sizes, however, it does not offer a secure connection to the bottle neck. The only point of contact between the tapered plug and the bottle is about the top rim of the neck. This single point of contact can allow the tapered plug to be easily dislodged with minimal force. While the tapered plug is quicker attach and detach, the use of caps provides a more secure connection between the bottle fitting and the bottle neck.

Therefore it is the object of the present invention to provide a multi-fit, fast connect, bottle-to-dispenser system that securely attaches to a bottle. The present invention provides a universal adapter having a concentric stacking design that allows the universal adapter to be fitted to bottle necks of various sizes. A first fitting, having a first plurality of ribs positioned along a first body, is concentrically connected to a second fitting having a second plurality of ribs positioned along a second body. Either the first fitting or the second fitting is used depending on the size of the bottle neck; the first plurality of ribs or the second plurality of ribs providing a tight and secure seal between the universal adapter and the bottle neck. With the universal adapter in place, a connecting tube is positioned through the universal adapter into the bottle. The opposite end of the connecting tube is then attached to the liquid dispensing pump via a dispenser coupling. The connecting tube allows the bottle to be placed anywhere below the counter and allows for easier access for refilling or replacement of the bottle. To refill the bottle the user simply removes the universal adapter and takes the bottle out where he or she may comfortably refill the bottle. Alternatively, the user may simply replace the bottle by quickly and easily switching the universal adapter between bottles.

### BRIEF DESCRIPTION OF THE DRAWINGS

FIG. 1 is an exploded perspective view of the present invention.

FIG. 2 is a perspective view of the present invention, wherein the connecting tube is externally coupled to the dispenser coupling and is positioned through the universal adapter into the container body, and wherein the down stem is positioned into the dispenser coupling.

FIG. 3 is a perspective view wherein the present invention is integrated with a sink countertop.

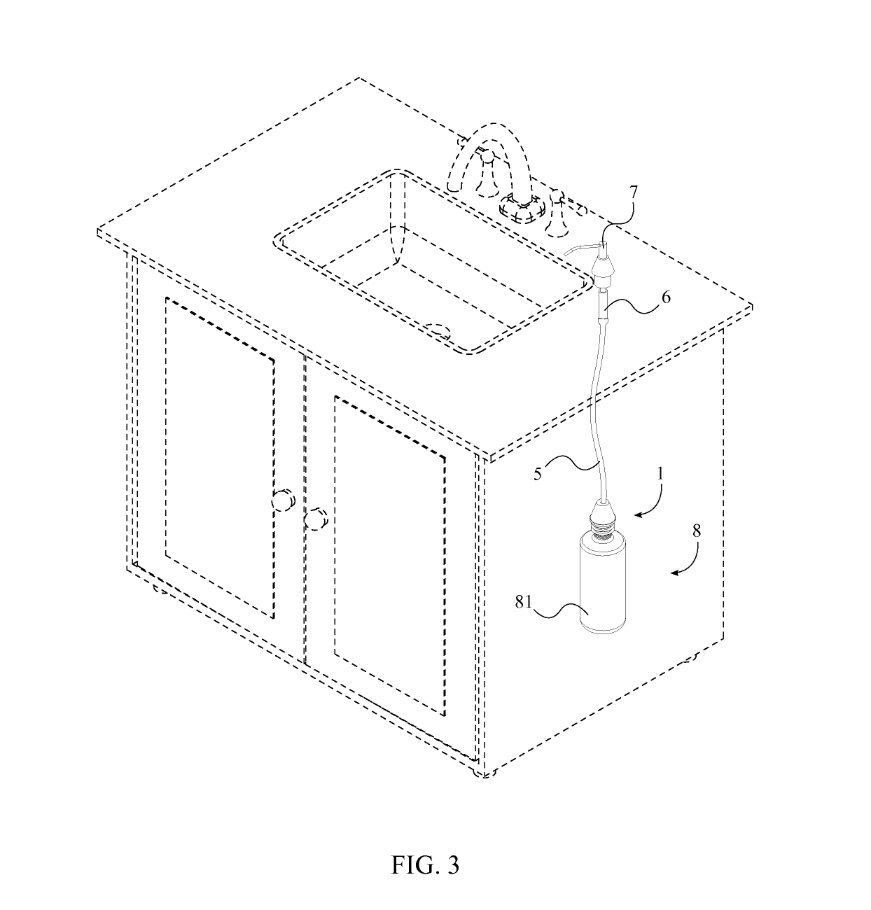

FIG. 4 is perspective view of the universal adapter.

FIG. 5 is a front elevational view of the universal adapter, depicting the first diameter of the first plurality of ribs and the second diameter of the second plurality of ribs.

FIG. 6 is a bottom plan view of the universal adapter.

FIG. 7A is a perspective view of the universal adapter being aligned with a bottle being under a half gallon; and

FIG. 7B is a perspective view thereof, wherein the first fitting is positioned into the neck.

FIG. 8A is a perspective view of the universal adapter being aligned with a bottle being over a half gallon; and

FIG. 8B is a perspective view thereof, wherein the second fitting is positioned into the neck.

FIG. 9A is a front elevational view of the dispenser coupling; and

FIG. 9B is a sectional view thereof, depicting the inner variable diameter.

### DETAIL DESCRIPTIONS OF THE INVENTION

All illustrations of the drawings are for the purpose of describing selected versions of the present invention and are not intended to limit the scope of the present invention.

The present invention is a multi-fit, fast connect, bottle-to-dispenser system for connecting a liquid dispensing pump 7 to the liquid reserve in a bottle 8 located underneath the counter or other distal location from the liquid dispensing pump 7; the liquid dispensing pump 7 having a down stem 70 and the bottle 8 having a neck 80 and a container body 81. In particular, the present invention is meant for liquid dispensers integrated into the sink or counter. The multi-fit, fast connect, bottle-to-dispenser system allows a user to easily connect the liquid dispensing pump 7 on the counter to the bottle 8, or other liquid reservoir, located beneath the counter.

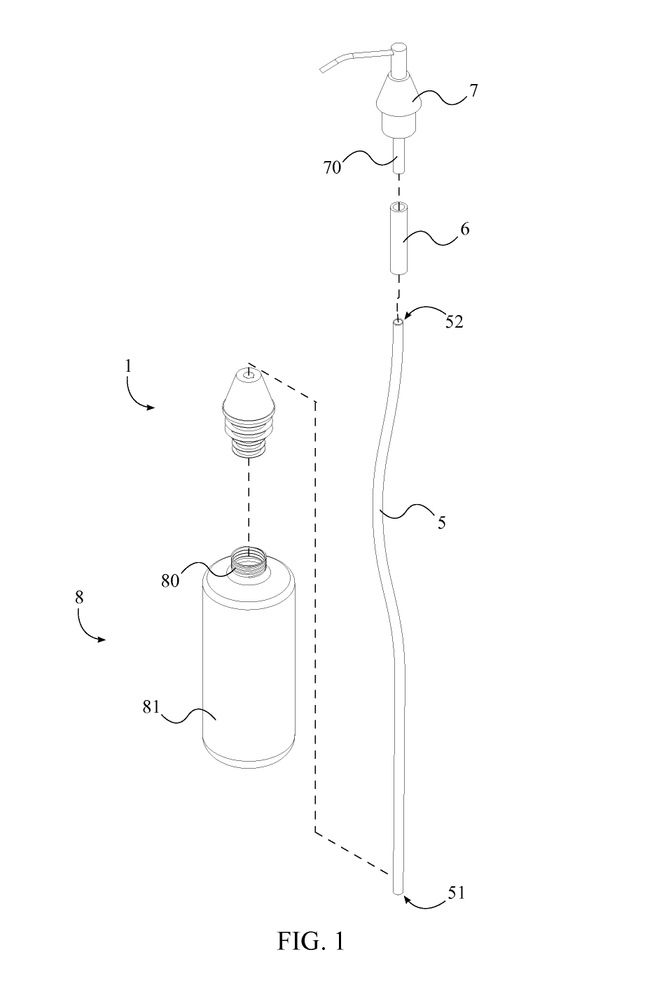

In reference to FIG. 1, the multi-fit, fast connect, bottle-to-dispenser system comprises a universal adapter 1, a connecting tube 5, and a dispenser coupling 6. The universal adapter 1 is attached to the bottle 8 and is compatible with a wide variety of bottles. In the preferred embodiment of the present invention, the universal adapter 1 is particularly designed to fit the two main industrial bottle 8 sizes: bottles a half gallon and under, and bottles over a half gallon. In other embodiments of the present invention, the universal adapter 1 may be designed for non-industrial or otherwise differently sized bottles. The connecting tube 5 and the dispenser coupling 6 provide a means for delivering the contents of the bottle 8 to the liquid dispensing pump 7.

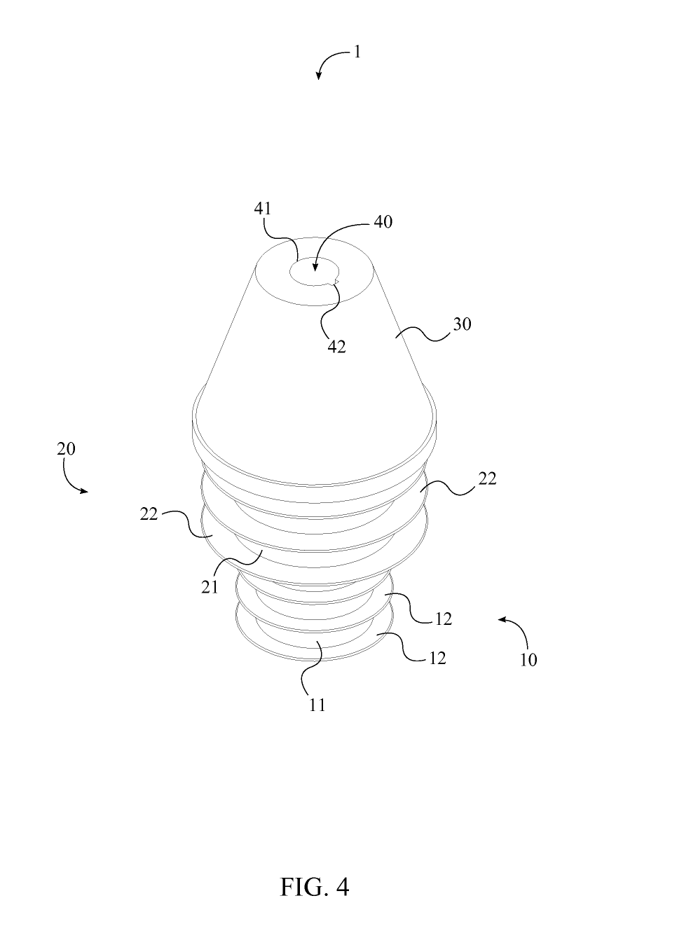

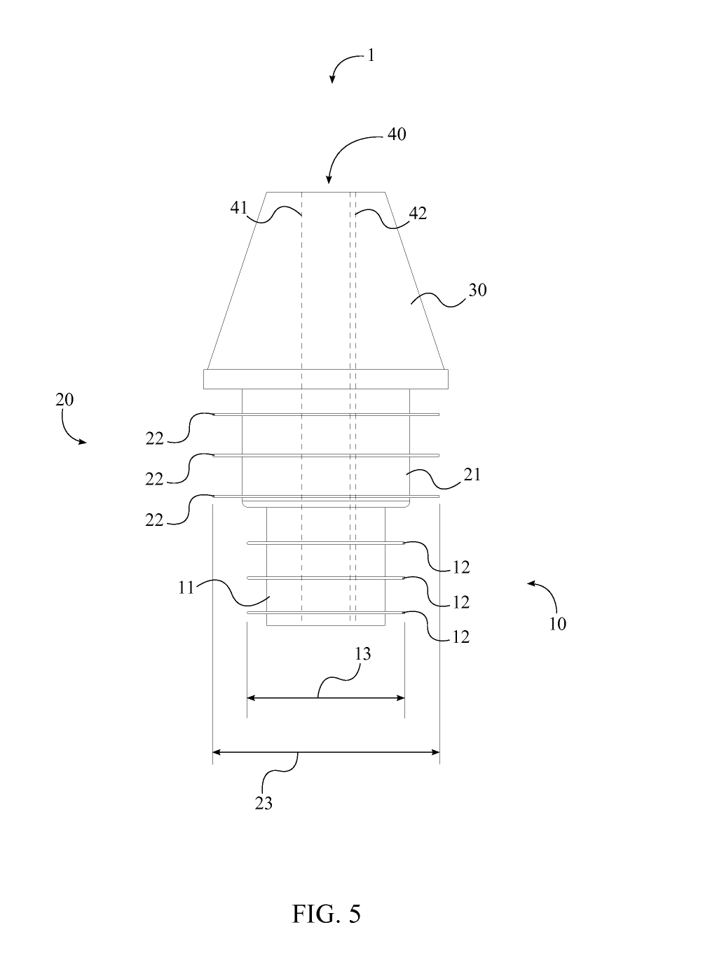

In reference to FIG. 4-5, the universal adapter 1 comprises a first fitting 10, a second fitting 20, a stop 30, and a pass through channel 40. The first fitting 10, the second fitting 20, and the stop 30 are concentrically aligned; the first fitting 10 being concentrically connected to the second fitting 20, and the stop 30 being concentrically connected to the second fitting 20 opposite the first fitting 10. In this way, the first fitting 10 forms a lower region of the universal adapter 1, the second fitting 20 forms a middle region of the universal adapter 1, and the stop 30 forms an upper region of the universal adapter 1. The lower region, the middle region, and the upper region each have a different diameter, allowing the universal adapter 1 to be fitted to multiple bottle 8 sizes.

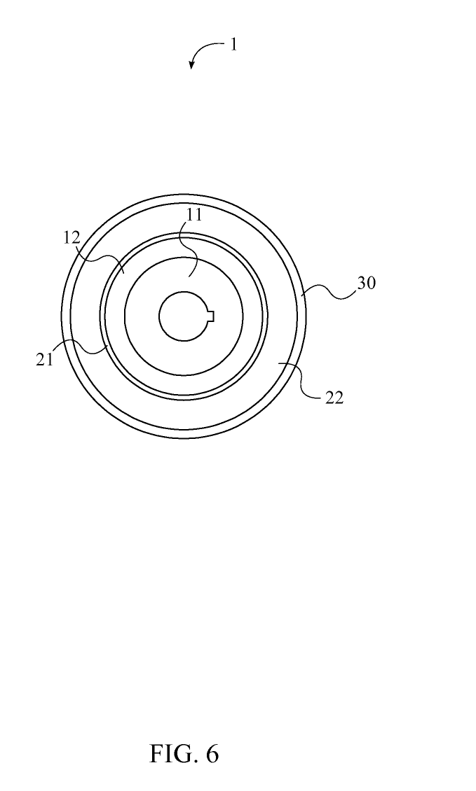

In reference to FIG. 5-6, the first fitting 10 comprises a first body 11, a first plurality of ribs 12, and a first diameter 13. The first body 11 is a cylindrical member that defines the length of the first fitting 10. The first plurality of ribs 12 is adjacently connected to the first body 11, wherein the first plurality of ribs 12 encircles the first fitting 10. Furthermore, the first plurality of ribs 12 is positioned along the first body 11. Each of the first plurality of ribs 12 is a flexible member that protrudes outwards from the first body 11. The first diameter 13 defines the radial expansion of the first plurality of ribs 12 from the first body 11.

In further reference to FIG. 5-6, the second fitting 20 comprises a second body 21, a second plurality of ribs 22, and a second diameter 23. Similar to the first body 11, the second body 21 is a cylindrical member that defines the length of the second fitting 20.

The second plurality of ribs 22 is adjacently connected to the second body 21, wherein the second plurality of ribs 22 encircles the second fitting 20. Furthermore, the second plurality of ribs 22 is positioned along the second body 21. Each of the second plurality of ribs 22 is a flexible member that protrudes outwards from the second body 21. The second diameter 23 defines the radial expansion of the second plurality of ribs 22 from the second body 21, wherein the first diameter 13 is smaller than the second diameter 23.

The first body 11 is concentrically connected to the second body 21, wherein the second plurality of ribs 22 extends outwards, past the first plurality of ribs 12, as depicted in FIG. 6. The first body 11 and the second body 21 are positioned into the bottle 8, through the neck 80, wherein the first plurality of ribs 12 and the second plurality of ribs 22 form a tight seal with the neck 80 of the bottle 8, ensuring that the universal adapter 1 is securely attached to the bottle 8. In the preferred embodiment of the present invention, the first diameter 13 is greater than or equal to the inner diameter of the neck 80 of the bottle 8 being a half gallon or under, while the second diameter 23 is greater than or equal to the inner diameter of the neck 80 of the bottle 8 being over a half gallon.

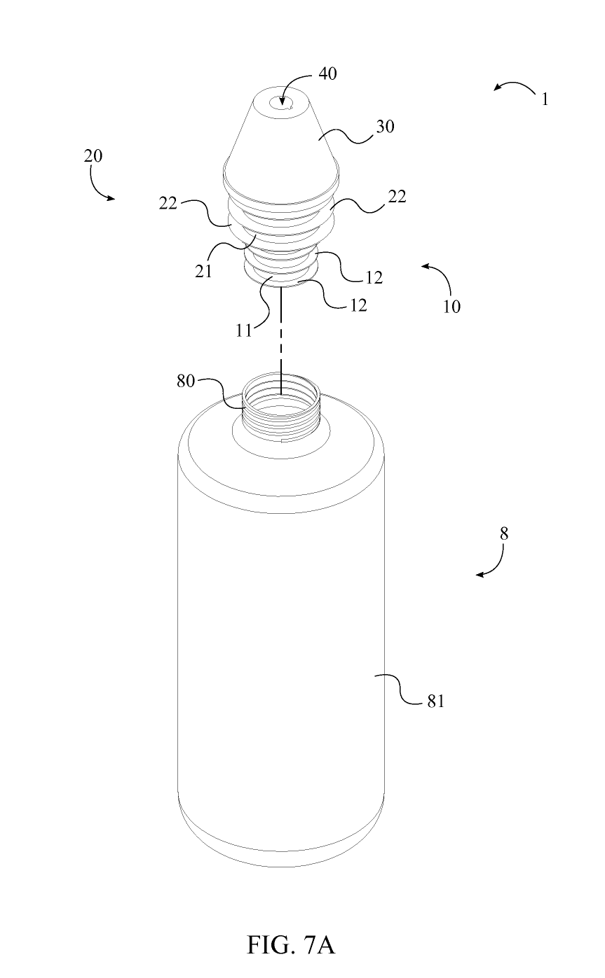

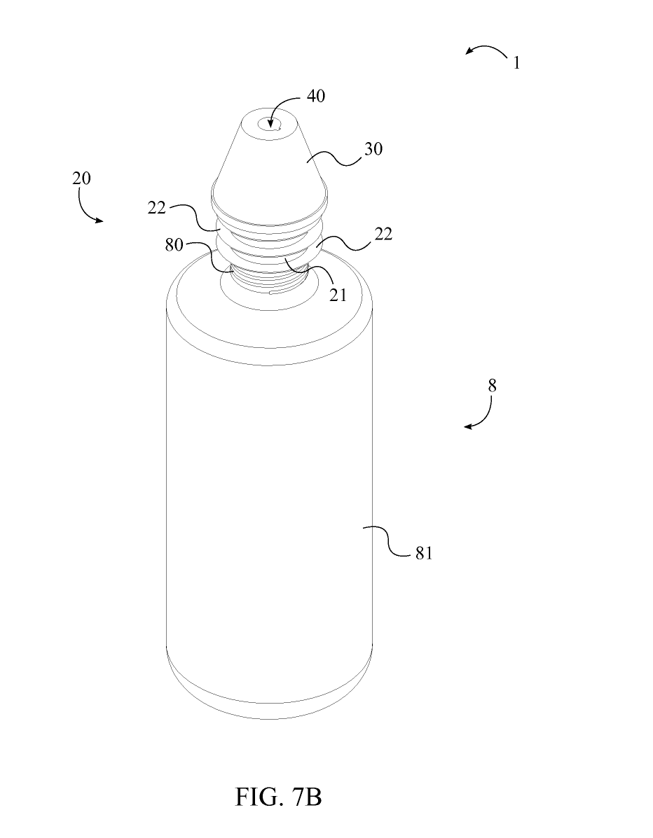

In reference to FIG. 7A-7B, for smaller bottles, the first fitting 10 is positioned into the neck 80, wherein the first plurality of ribs 12 forms a tight seal with the neck 80; the bottom most rib forming a seal between the neck 81 finish and the container body 81 start, and the upper ribs forming a seal with the interior surface of the neck 80. Meanwhile, the second fitting 20 is positioned adjacent to the neck 80 opposite the container body 81, wherein the second fitting 20 covers the top opening of the bottle 8 through the neck 80. Either the diameter of the second body 21 or the second diameter 23 is greater than the diameter of the neck 80, such that the second body 21 or the lowermost rib of the second plurality of ribs 22, respectively, rests on top of the neck 80.

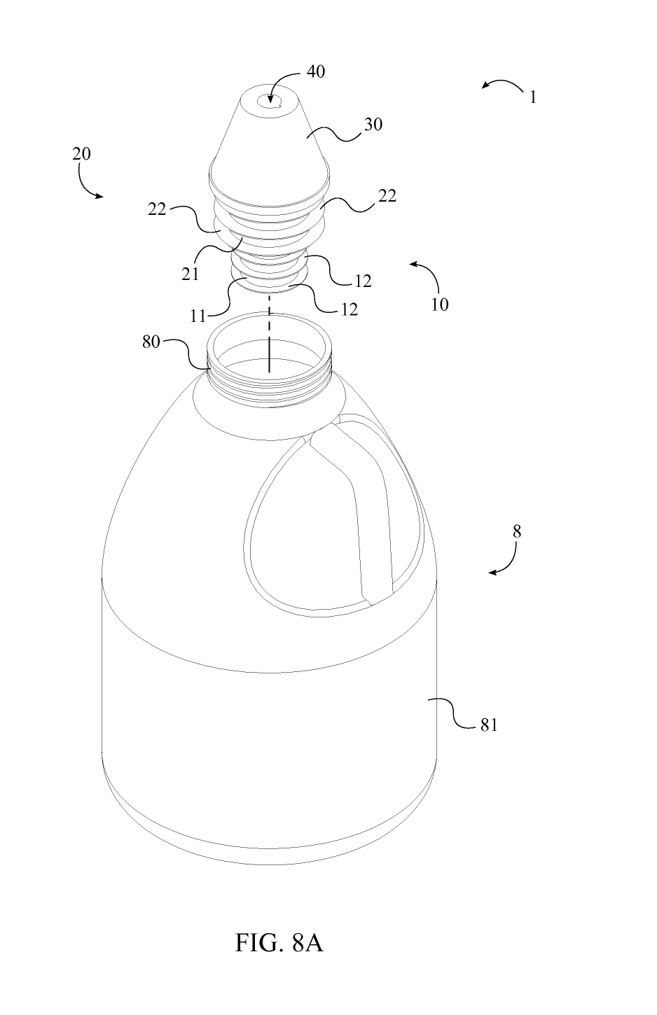

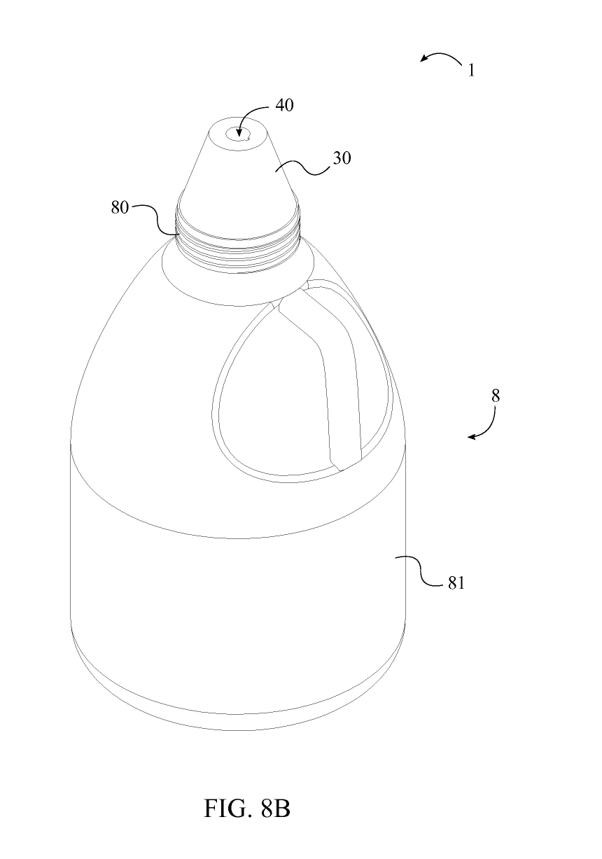

In reference to FIG. 8A-8B, for larger bottles, the second fitting 20 is positioned into the neck 80, wherein the second plurality of ribs 22 forms a tight seal with the neck 80; the bottom most rib forming a seal between the neck 81 finish and the container body 81 start, and the upper ribs forming a seal with the interior surface of the neck 80. Meanwhile, the stop 30 is positioned adjacent to the neck 80 opposite the container body 81, wherein the stop 30 covers the top opening of the bottle 8 through the neck 80. The diameter of the stop 30 is greater than the diameter of the neck 80, such that the stop 30 rests on top of the neck 80. As such, the stop 30 is concentrically connected to the second body 21 opposite the first body 11. In the preferred embodiment of the present invention, the stop 30 is tapered away from the second fitting 20, having a conical shape.

In the preferred embodiment of the present invention, the first body 11 and the second body 21 are the same length. Furthermore, the first plurality of ribs 12 and the second plurality of ribs 22 are each specifically three ribs. The use of three ribs for both the first plurality of ribs 12 and the second plurality of ribs 22 provides optimal stability when the universal adapter 1 is positioned into the neck 80, ensures a complete seal between the universal adapter 1 and the neck 80, and allows for the adaptability of the universal adapter 1 to various lengths in the neck 80 of bottles. However, it is possible for the first plurality of ribs 12 and the second plurality of ribs 22 to have more or less ribs in other embodiments of the present invention.

In reference to FIG. 5, the pass through channel 40 traverses through the stop 30, the second fitting 20, and first fitting 10, wherein the pass through channel 40 is in fluid communication with the container body 81 and allows the connecting tube 5 to be positioned into the bottle 8 through the universal adapter 1. The pass through channel 40 comprises a tube channel 41 and a ventilation channel 42. The tube channel 41 is round, and is designed to receive the connecting tube 5, wherein a first end 51 of the connecting tube 5 is positioned through the tube channel 41 into the container body 81. In the preferred embodiment of the present invention, the diameter of the tube channel 41 is marginally smaller than the outer diameter of the connecting tube 5, ensuring a tight, secure fit that prevents the connecting tube 5 from inadvertently being dislodged from the universal adapter 1.

Meanwhile, the ventilation channel 42 is positioned adjacent to the tube channel 41 and allows air to enter the bottle 8 to facilitate the delivery of the contents of the bottle 8 to the liquid dispensing pump 7 through the connecting tube 5. In the preferred embodiment of the present invention, the ventilation channel 42 is a rectangular notch that traverses into the tube channel 41, creating an airflow along the connecting tube 5. The ventilation channel 42 may be shaped otherwise in other embodiments of the present invention. Furthermore, the location of the ventilation channel 42 may vary in other embodiments of the present invention. For example, the ventilation channel 42 may be positioned away from the tube channel 41, closer to the outer edge of the universal adapter 1.

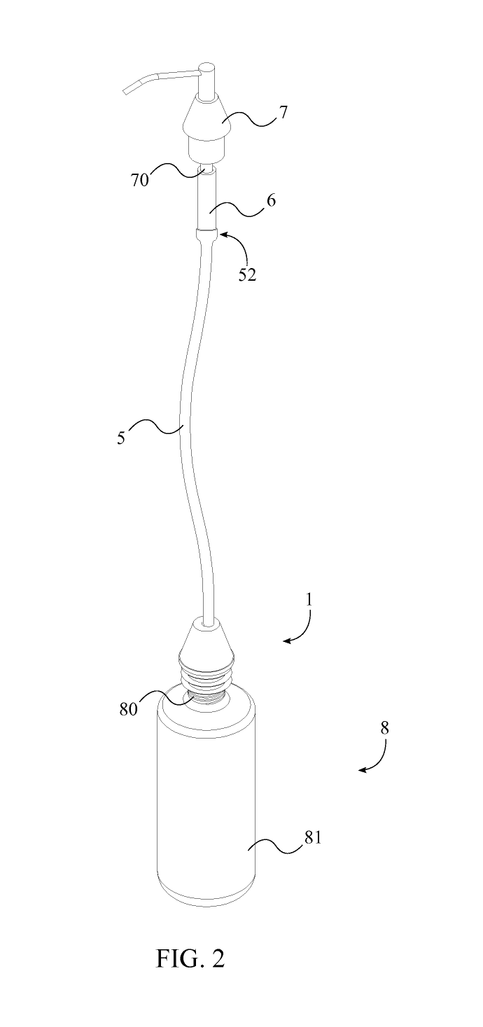

In reference to FIG. 1-2, the connecting tube 5 is a hollow, cylindrical extrusion of material having a certain length. The outer diameter of the connecting tube 5 is marginally larger than the diameter of the tube channel 41 of the pass through channel 40 as described above. The length of the connecting tube 5 may vary between different embodiments of the present invention. The only restriction in regards to the length of the connecting tube 5 is that the connecting tube 5 must be long enough in order to extend from the location of the liquid dispensing pump 7 in the counter to the bottle 8 positioned below the counter. Ideally the connecting tube 5 is a flexible material, such that one length can be produced, wherein excess length of the connecting tube 5 can easily be stored and managed. In the preferred embodiment of the present invention, the connecting tube 5 is constructed from polyvinyl chloride, however, any other materials may be used in other embodiments, including rigid materials.

In further reference to FIG. 1-2, the dispenser coupling 6 is a hollow, cylindrical extrusion of material that is used to attach the connecting tube 5 to the down stem 70 of the liquid dispensing pump 7, wherein the connecting tube 5 is in fluid communication with the down stem 70 through the dispenser coupling 6. As such, the dispenser coupling 6 is terminally attached to the connecting tube 5 opposite the universal adapter 1, wherein the connecting tube 5 is positioned into the dispenser coupling 6. The down stem 70 is also attached to the dispenser coupling 6, wherein the down stem 70 is positioned into the dispenser coupling 6 opposite the connecting tube 5.

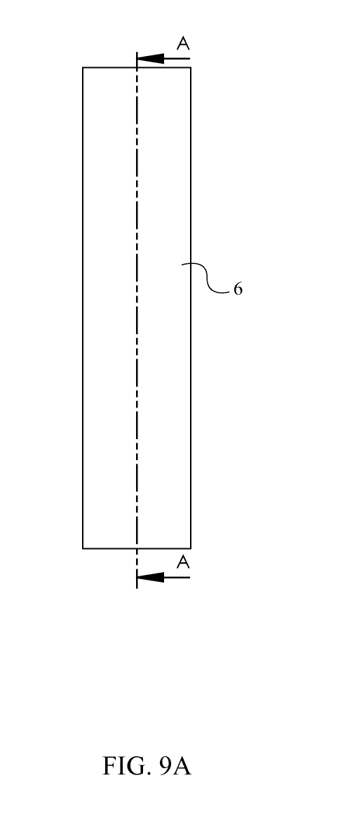

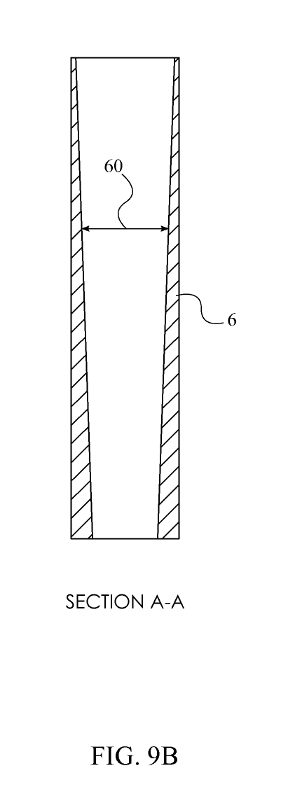

In reference to FIG. 9A-9B, the dispenser coupling 6 comprises a variable inner diameter 60, wherein the variable inner diameter 60 is tapered along the dispenser coupling 6, determining the open cross section of the dispenser coupling 6. A second end 52 of the connecting tube 5 is externally coupled to the dispenser coupling 6, adjacent to the narrow opening of the dispenser coupling 6, as the connecting tube 5 has a fixed outer diameter. In this way, the variable inner diameter 60 widens as the dispenser coupling 6 traverses away from the connecting tube 5. The widening of the dispenser coupling 6 allows the dispenser coupling 6 to be fitted around liquid dispensing pumps having down stems of different diameter. Furthermore, the tapered interior design of the dispenser coupling 6 provides enhanced fluid flow through the liquid dispensing pump 7 as opposed to traditional systems. Traditionally, a straw is positioned into the down stem 70 as opposed to being positioned around the down stem 70. The positioning of the dispenser coupling 6 around the down stem 70 creates a larger cross sectional area through which fluid can flow into the down stem 70, thus providing faster flow and overall pump performance.

In some embodiments of the present invention, the dispenser coupling 6 can be ignored, wherein the connecting tube 5 is directly attached to the down stem 70. In such an embodiment, the connecting tube 5 may either have a tapered terminal end that allows the connecting tube 5 to be positioned around down stems having various diameters. Similar to the variable inner diameter 60 of the dispenser coupling 6, the tapered terminal end of the connecting tube 5 provides a tapered hollow section to receive the down stem 70. Alternatively, the connecting tube 5 can be constructed from a substantially flexible material as to allow the connecting tube 5 to stretch around the down stem 70 and conform to down stems having various diameters.

In order to use the present invention, the user first removes the straw, or dip tube, from the down stem 70 and removes the cap from the bottle 8. The universal adapter 1 is then positioned into the neck 80, wherein either the first plurality of ribs 12 or the second plurality of ribs 22, depending on the size of the neck 80, forms a tight seal with the neck 80. The connecting tube 5 is then positioned through the pass through channel 40 into the container body 81; more specifically, through the tube channel 41. The dispenser coupling 6 is then terminally attached to the connecting tube 5 opposite the universal adapter 1. Finally, the dispenser coupling 6 is fitted around the down stem 70, wherein the liquid dispensing pump 7 is in fluid communication with the contents of the container body 81 through the connecting tube 5 and the dispenser coupling 6. The user can then prime the connecting tube 5 and the dispenser coupling 6 by pumping the liquid dispensing pump 7, and subsequently dispense the contents of the container body 81 by performing the same action. When the bottle 8 is empty, the universal adapter 1 is simply removed from the neck 80, leaving the connecting tube 5 intact and then positioned into the neck 80 of a subsequent bottle.

Although the invention has been explained in relation to its preferred embodiment, it is to be understood that many other possible modifications and variations can be made without departing from the spirit and scope of the invention as hereinafter claimed.

What is claimed is:

1. A multi-fit, fast connect, bottle-to-dispenser system comprises:
a universal adapter;
the universal adapter comprises a first fitting, a second fitting, a stop, and a pass through channel;
the first fitting comprises a first body, a first plurality of ribs, and a first diameter;
the second fitting comprises a second body, a second plurality of ribs, and a second diameter;
the first body being concentrically connected to the second body;
the stop being concentrically connected to the second body opposite the first body;
the first plurality of ribs encircling the first body;
the first plurality of ribs being positioned along the first body;
the second plurality of ribs encircling the second body;
the second plurality of ribs being positioned along the second body;
the first diameter being smaller than the second diameter; and
the pass through channel traversing through the stop, the second body, and the first body.

2. The multi-fit, fast connect, bottle-to-dispenser system as claimed in claim 1 comprises:
a connecting tube; and
a first end of the connecting tube traversing through the pass through channel.

3. The multi-fit, fast connect, bottle-to-dispenser system as claimed in claim 2 comprises:
a dispenser coupling; and
the dispenser coupling being terminally attached to the connecting tube opposite the universal adapter.

4. The multi-fit, fast connect, bottle-to-dispenser system as claimed in claim 3 comprises:
the dispenser coupling comprises a variable inner diameter; and
the variable inner diameter being tapered along the dispenser coupling.

5. The multi-fit, fast connect, bottle-to-dispenser system as claimed in claim 3 comprises:
a second end of the connecting tube being externally coupled to the dispenser coupling.

6. The multi-fit, fast connect, bottle-to-dispenser system as claimed in claim 3 comprises:
a liquid dispensing pump comprises a down stem;
the dispenser coupling being attached to the down stem; and
the down stem being positioned into the dispenser coupling opposite the connecting tube.

7. The multi-fit, fast connect, bottle-to-dispenser system as claimed in claim 2 comprises:
a liquid dispensing pump comprises a down stem;
the connecting tube being attached to the down stem; and
the down stem being positioned into the connecting tube opposite the universal adapter.

8. The multi-fit, fast connect, bottle-to-dispenser system as claimed in claim 2 comprises:
the pass through channel comprises a tube channel and a ventilation channel;
the ventilation channel being positioned adjacent to the tube channel; and
the connecting tube being positioned through the tube channel.

9. The multi-fit, fast connect, bottle-to-dispenser system as claimed in claim 1 comprises:
a bottle comprises a neck and a container body;
the universal adapter being positioned into the neck; and
the pass through channel being in fluid communication with the container body.

10. The multi-fit, fast connect, bottle-to-dispenser system as claimed in claim 9 comprises:
the first fitting being positioned into the neck; and
the second fitting being positioned adjacent to the neck opposite the container body.

11. The multi-fit, fast connect, bottle-to-dispenser system as claimed in claim 9 comprises:
the second fitting being positioned into the neck; and
the stop being positioned adjacent to the neck opposite the container body.

12. A multi-fit, fast connect, bottle-to-dispenser system comprises:
a universal adapter;
a connecting tube;
the universal adapter comprises a first fitting, a second fitting, a stop, and a pass through channel;
the first fitting comprises a first body, a first plurality of ribs, and a first diameter;
the second fitting comprises a second body, a second plurality of ribs, and a second diameter;
the pass through channel comprises a tube channel and a ventilation channel;
the first body being concentrically connected to the second body;
the stop being concentrically connected to the second body opposite the first body;
the first plurality of ribs encircling the first body;
the first plurality of ribs being positioned along the first body;
the second plurality of ribs encircling the second body;
the second plurality of ribs being positioned along the second body;
the first diameter being smaller than the second diameter;
the pass through channel traversing through the stop, the second body, and the first body;
the ventilation channel being positioned adjacent to the tube channel; and
a first end of the connecting tube traversing through the tube channel.

13. The multi-fit, fast connect, bottle-to-dispenser system as claimed in claim 12 comprises:
a dispenser coupling; and
the dispenser coupling being terminally attached to the connecting tube opposite the universal adapter.

14. The multi-fit, fast connect, bottle-to-dispenser system as claimed in claim 13 comprises:
the dispenser coupling comprises a variable inner diameter; and
the variable inner diameter being tapered along the dispenser coupling.

15. The multi-fit, fast connect, bottle-to-dispenser system as claimed in claim 13 comprises:
a second end of the connecting tube being externally coupled to the dispenser coupling.

16. The multi-fit, fast connect, bottle-to-dispenser system as claimed in claim 13 comprises:
a liquid dispensing pump comprises a down stem;
the dispenser coupling being attached to the down stem; and
the down stem being positioned into the dispenser coupling opposite the connecting tube.

17. The multi-fit, fast connect, bottle-to-dispenser system as claimed in claim 12 comprises:
a liquid dispensing pump comprises a down stem;
the connecting tube being attached to the down stem; and
the down stem being positioned into the connecting tube opposite the universal adapter.

18. The multi-fit, fast connect, bottle-to-dispenser system as claimed in claim 12 comprises:
a bottle comprises a neck and a container body;
the universal adapter being positioned into the neck; and
the connecting tube being positioned through the pass through channel into the container body.

19. The multi-fit, fast connect, bottle-to-dispenser system as claimed in claim 18 comprises:
the first fitting being positioned into the neck; and
the second fitting being positioned adjacent to the neck opposite the container body.

20. The multi-fit, fast connect, bottle-to-dispenser system as claimed in claim 18 comprises:
the second fitting being positioned into the neck; and
the stop being positioned adjacent to the neck opposite the container body.
